(19) United States
(12) Patent Application Publication
(10) Pub. No.: US 2022/0136737 A1
(43) Pub. Date: May 5, 2022

(54) INSULATING ROOF WITH RADIANT HEATING AND COOLING

(71) Applicant: Will John Temple, Placerville, CA (US)

(72) Inventor: Will John Temple, Placerville, CA (US)

(21) Appl. No.: 17/520,646

(22) Filed: Nov. 6, 2021

Related U.S. Application Data
(63) Continuation-in-part of application No. 16/554,322, filed on Aug. 28, 2019.
Application No. 16/554,322 is a continuation-in-part of application No. 16/726,742, filed on Dec. 24, 2019.
(60) Provisional application No. 63/119,485, filed on Nov. 30, 2020.

(51) Int. Cl. F24S 20/67; F24S 10/40; F24S 30/425; F24S 80/54; F24S 60/10

(52) U.S. Cl. CPC F24S 20/67; F24S 10/45; F24S 60/10; F24S 80/54; F24S 30/425

(57) ABSTRACT

A roof or wall comprising an insulating selective surface (1) for the use of transferring net heat energy into or out of an enclosure, such as a building. The insulating selective surface comprises at least one transparent cover (2) that comprises a chamber (9), and in the chamber is a moveable plate (4) comprising a plurality of surfaces (5, 6). At least one of the surfaces is a selective surface which can be moved to substantially face the sky, or moved to face away from the sky. The device insulates the enclosure from conductive losses, while using the sun to heat the enclosure, or the cold of deep space to cool the enclosure depending on how the plate is moved.

### CROSS-REFERENCE TO RELATED APPLICATIONS

This application claims the benefit of Provisional Patent Application No. 63/119,485 filed Nov. 30, 2020 and regular patent application Ser. No. 16/554,322 filed Aug. 20, 2019 and regular patent application Ser. No. 16/726,742 filed Dec. 24, 2019 by the present inventor, which are incorporated by reference.

### BACKGROUND-FIELD OF INVENTION

The disclosed embodiments relate generally to utilizing radiant energy exchange to transfer heat energy into and out of an enclosure, while insulating with regards to conductive heat transfer.

### BACKGROUND-DESCRIPTION OF PRIOR ART

Surfaces generally transfer heat energy through conduction, convection, and radiant energy exchange. With regards to radiant energy transfer, a surface absorbs what it doesn't reflect, scatter, or transmit. For a given wavelength, common materials emit and absorb the same percentage of the values of a blackbody. For this disclosure, the term “reflect”, and its variations, are not limited to perfect reflection. Herein white surfaces, or any surfaces that scatter radiation back, are reflective surfaces.

However, a surface may be a “selective surface”, which is a surface that has different absorption and emittance values for different wavelengths and bandwidths. Selective surfaces are known, and there are two general types. A first type is a surface that has high absorption in the visible light region to absorb solar radiation. This selective surface also has low absorption, and thus emittance in the infrared. This type of selective surface both absorbs sunlight and yet it emits little infrared radiation that would cool the surface off. So, this type of selective surface is effective at both capturing solar radiation, and holding on to it. This type is a preferred surface for solar thermal applications.

For this disclosure, the term “infrared” will generally refer to the long-wavelength infrared range. This is the radiant band within which the Earth, and objects on the Earth radiate. The term “visible” will generally include both visible light and the near infrared, as this is the range in which the Sun radiates. Glass, for example, generally transmits both visible and near infrared sunlight, but is generally opaque to longer wavelengths.

A second type of selective surface is one that is highly reflective to solar radiation (sunlight), but highly emissive to infrared radiation. This type of selective surface performs in the opposite manner of the first type. It is a preferred surface for cooling, as it can emit more radiation up to the sky and into space than it absorbs from the Sun.

An example of a surface is the roof of a building. If the roof comprises the first type of selective surface it can warm a building, which is generally useful during the Winter months. But this type will also warm the building during the Summer, which is generally undesirable. The second type of selective surface will do the opposite, which is cool the building during the Summer, but it also cools the building during the Winter.

The second type, which comprises radiant cooling, has been proposed as a solution for cooling the planet. In many of these cases, white paint, which is often a selective surface, has been suggested. However, if the building is also cooled in Winter, and the building is heated by fossil fuels, then more fossil fuel will be needed. This offsets the other gains. If a building is cooled by AC, which is a heat pump, but warmed with fossil fuels, then a building would likely lose more than it would gain from a radiant cooling roof.

What is needed are enclosing surfaces, roofs and walls in particular, that can change behavior to satisfy both the needs of radiant heating and radiant cooling, often depending on the season. What is also needed is for a surface, roofs and walls in particular, that can insulate an enclosure, such as a building.

What is also needed is a cost-effective solution that enables enclosures and buildings to be warmed or cooled without any external energy source, other than the Sun and the cold of deep space. Roofs and walls that can have a positive net transfer of heat energy into and out of a building is highly desirable.

### BRIEF DESCRIPTION OF THE DRAWINGS

For a better understanding of the embodiments of the invention, as well as additional embodiments thereof, reference should be made to the Description of Embodiments below, in conjunction with the following drawings, in which like reference numerals refer to corresponding parts throughout the figures.

FIG. 1 illustrates a perspective view of a section of an insulating selective surface in accordance with some embodiments.

FIG. 2 illustrates a cross-sectional view of an insulating selective surface in accordance with some embodiments.

FIG. 3 illustrates a cross-sectional view of an insulating selective surface in accordance with some embodiments.

FIG. 4 illustrates a cross-sectional top view of an insulating selective surface in accordance with some embodiments.

FIG. 5 illustrates a cross-sectional side view of an insulating selective surface a in accordance with some embodiments.

FIG. 6 illustrates a cross-sectional view of an insulating selective surface in accordance with some embodiments.

FIG. 7 illustrates a cross-sectional view of an insulating selective surface in accordance with some embodiments.

FIG. 8 illustrates a cross-sectional view of an insulating selective surface in accordance with some embodiments.

FIG. 9 illustrates a cross-sectional view of an insulating selective surface in accordance with some embodiments.

FIG. 10 illustrates a cross-sectional view of an enclosure in accordance with some embodiments.

FIG. 11 illustrates a cross-sectional view of an insulating selective surface in accordance with some embodiments.

FIG. 12 illustrates a cross-sectional view of an insulating selective surface in accordance with some embodiments.

FIG. 13 illustrates a cross-sectional view of an insulating selective surface in accordance with some embodiments.

FIG. 14 illustrates a selective surface roof comprising an array in accordance with some embodiments.

FIG. 15 illustrates a top view of a selective surface roof comprising an array in accordance with some embodiments.

FIG. 16 illustrates a cross-sectional view of an enclosure in accordance with some embodiments.

FIG. 17 illustrates a cross-sectional view of a selective surface roof comprising an array in accordance with some embodiments.

FIG. 18 illustrates a cross-sectional view of a selective surface roof comprising an array in accordance with some embodiments.

FIG. 19 illustrates a method of control of an insulated selective surface roof or wall comprising steps in accordance with some methods.

### REFERENCE NUMERALS IN DRAWINGS

1 Insulating Selective Surface (Roof/Wall)
2 Transparent Top Cover (May comprise Transparent PV Cells)
3 Bottom Cover
4 Rotatable Plate with Selective Surface(s)
5 Selective Heat Absorbing Surface
6 Emissive Surface
7 Axis of Rotation
8 Wheel
9 Chamber
10 Magnetic North Pole
11 Magnetic South Pole
12 Magnetic North Pole
13 Magnetic South Pole
14 Magnetic Bar
15 Building
16 Interior
17 Thermal Energy Storage (TES) (May also comprise PCM)
18 Third Surface
19 Fourth Surface
20 Left Plate
21 Right Plate
22 Heat Pump
23 Heat Exchanger
24 Heat Exchanger
25 Heat Exchanger
26 Pump
27 Throttle
28 Aerogel Insulation
29 Aerogel Insulation
30 Arc Shape
31 Arc Shape
32 Circle Shape (Cross-Section of Ball or Rod)
100 Control System
101 Sensor(s) (Thermometer(s), Flow Sensor(s), etc.)
102 Computing Device
103 Clock (Time(s))
104 Electrical Power
105 Heat Transfer System (Cooling or Heating)
106 Data
107 Network
108 Programming
109 Signal
110 Battery
112 Communications System
201 Step (Exceed Temperature Threshold)
202 Step (Move Plates)
203 Step (Communicate)
204 Step (Determine Charge)

### DETAILED DESCRIPTION OF THE EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known and/or common processes, mechanisms, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms may only be used to distinguish one element from another. For example, a first element could be termed a second element, and, similarly, a second element could be termed a first element, without departing from the scope of the present invention.

The terminology, used in the description of the invention herein, is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or”, as used herein, refers to and encompasses any and all possible combinations of one or more of the associated listed items. It will be further understood that the terms “comprises” and/or “comprising,” when used in this specification, specify the presence of stated features, steps, methods, operations, elements, and/or components, but do not preclude the presence or addition of one or more other features, steps, methods, operations, elements, and/or components thereof.

Embodiments of a thermal energy transfer system and/or device, and associated processes for using such devices are described. In some embodiments, the invention is an insulating roof for a building that heats and/or cools through radiant heat exchange. It should be understood, however, that some of the embodiments may be applied to other devices, such as, but not limited to, walls, enclosures for thermal energy storage, or any enclosure that faces the sky or other radiant source, such as a vehicle.

In the examples about to be disclosed, many of the embodiments are for the use of moving heat energy into or out of an enclosure.

Attention is now directed towards embodiments of the device.

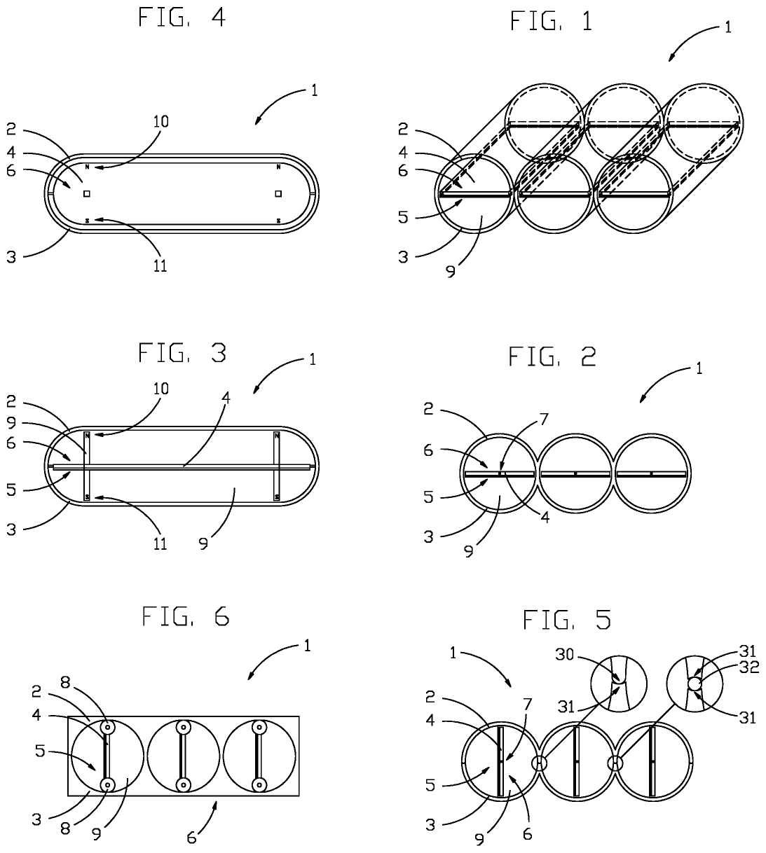

FIG. 1 illustrates a perspective view of an array of tubes that comprise the insulating selective surface 1. FIG. 2 illustrates a cross-section of the same embodiments. FIG. 3 illustrates a side view of the same embodiments. And FIG. 4 illustrates a top view of the same embodiments. The tubes are comprised of glass, but other transparent materials may be used, such as plexiglass or transparent wood. The tubes ideally comprise a vacuum chamber 9. For this disclosure, the term vacuum will refer to a vacuum, or to a partial vacuum, which is simply air pressure below the outside pressure. It is preferable for the invention to use a vacuum, or partial vacuum, to minimize conductive heat transfer, which generally transfers heat in an undesirable direction. However, the invention will still function without a vacuum, just not as well. So, the invention is not necessarily limited to having a vacuum chamber, although some embodiments may be.

In an aspect, the chambers 9 of the device may be comprised of gas, and gases within may be gases other than air. For example, it is common for the gas within the windows of a building to comprise argon, krypton, or xenon. These gases have a lower conductivity than air. In embodiments, the present embodiments may comprise these gases at full or other pressures. Other gases can also be used.

The tubes may be one piece, or may be comprised of a plurality of pieces. The transparent top cover 2 comprises the top surface of the tubes. It is the side that is exposed to the sky. The bottom cover 3 comprises the bottom surface of the tubes. It is the side that is exposed to the inside of the enclosure with which radiant energy is transferred. The bottom cover does not necessarily need to be transparent, and may be a different material.

Within the chamber 9 is a material comprising two sides referred herein as the rotatable plate 4. In this figure, the material comprises a flat sheet, but it is not limited to being flat. For an example and alternative, it could have a circular cross section. The material comprises at least two sides which in turn comprise materials having different material properties with regard to radiant absorptivity, reflectivity, and emissivity. In these figures, the material comprises the rotatable plate 4.

One of the sides of the rotatable plate comprises a selective heat absorbing surface 5. It comprises a first selective surface that is highly absorbent to solar irradiation, but also low in emissivity of infrared radiation. The other side is a second selective surface that comprises the emissive surface 6, which is highly emissive in the infrared. The emissive surface in this embodiment and example is also a selective surface. It is highly emissive in the infrared, but also highly reflective to solar irradiance. In an aspect, the term “highly” will also refer to any property that is greater than 65% of the value of a blackbody, just to draw a line in the sand to define the invention. Likewise in reference to radiative properties, the term “low” will refer to a property that is less than 35% of the value of a blackbody.

In an aspect, the term “insulating selective surface” in this disclosure refers to the assembly of covers that comprise one or more chambers, and the one or more rotatable plates within the chambers. Whereas the term “selective surface” here is in regards to the surfaces of just the plates. Theses surfaces do not insulate from one side of the plate to the other.

In an aspect of defining the terms of the invention, and in regards to the assembly of elements that make up an insulating selective surface, the term “insulating”, and its variations, means that insulation values will be equal to or greater than dual pane glass windows (R value of 2) when the movable plates are horizontal. Also, “insulating” is in regards to thermal conduction. In regards to what material fills the chamber between the top and bottom covers, “insulating” will refer to any material that has thermal conductivity equal to or less than air.

The rotatable plate 4 of this embodiment can be rotated to place one of the surfaces facing the sky for desirable radiant heat transfer, or to be rotated to a vertical position to allow radiation to pass by the rotatable plate.

For example, and in this embodiment and mode, during the daylight hours in Summer, the emissive surface 6 is rotated to be on top and faces the sky, if it was not already in that position. This surface is also highly reflective to sunlight. Sunlight striking the top surface of the transparent top cover will substantially pass through the top cover and strike the emissive surface. Since the emissive surface is also highly reflective to sunlight, the majority of direct and/or indirect sunlight will be reflected back through the transparent top cover, and substantially back out to space. A minority of the radiant energy will be absorbed.

In this example and embodiment, the top surface of the plate is highly emissive, and the bottom surface of the plate has low emissivity. The plate is also thermally conductive, and the plate will be substantially the same temperature on each side. Real world materials can achieve values of better than 90% emissivity for the top, and less than 10% emissivity for the bottom. So, the plate will emit more than 90% of the absorbed radiation back to the transmissible top cover. The top cover will absorb and then re-emit this radiation, both up into space, and back at the plate. How much depends on the material used for the top cover and how much it absorbs. In general, the top cover conducts and convects heat from the outside air, as well as receives the majority of radiant infrared energy from the plate. The energy balance comprises the top cover radiating out infrared in both directions, and this will cause the top cover to cool in this mode compared to the outside temperature. The cooler top cover keeps the temperature of the plate from substantially warming up, and may cool it.

Concurrently, the bottom cover emits radiation at the bottom surface of the plate which is substantially reflective and low in emissivity in the infrared range, and the net amount of radiation exchanged between the bottom cover and the bottom of the plate is quite small. Provided that heat conducted from the top cover to the bottom cover is very small in amount, as it can be in many of the embodiments of the invention, then the overall heat energy transferred from the temperature difference of the top and bottom covers will be low, and the insulating selective surface will highly insulate. This mode of operation will be referred to as insulate mode.

This example, however, is just part of the day. At night, when the sun is down, the plate is moved to a vertical position, as illustrated in FIGS. 5 and 6. In the vertical position, the plate is generally perpendicular to the top and bottom covers. In this position, the bottom cover emits substantially and directly at the top cover which highly absorbs this radiation. The top cover then re-radiates half this energy back to the bottom cover, but it also radiates half the energy up to the sky. In accordance with the first law of thermodynamics, the energy out matches the energy in for constant temperatures. The energy balance requires that at constant temperatures the top cover will cool to a temperature where the outgoing radiation and conductive losses equals the incoming. Because substantial infrared radiation is substantially absorbed from one net direction, which is from the bottom cover, and not the sky at night, but the top cover radiates in two directions, the radiative loss substantially outweighs the radiative gain. The difference is made up in the conductive and convective gain which substantially comes from the top cover cooling to below the outside air temperature and the bottom cover. As the top cover will be generally lower in temperature than the bottom cover, more infrared radiation energy will be transferred out of the bottom cover to the top cover than is received back from the top cover. This cools the bottom cover. In an aspect, the bottom cover is in thermal conductivity with the enclosure below it, which in this case is then cooled by the bottom cover. This mode and method of operation is referred to here as the cooling mode.

The cooling of an enclosure, such as the interior of a building happens substantially at night. The cooling heat transfer at night generally outweighs heat gain that might occur during the day. It is an advantage to the invention that meaningful heat is transferred out over the course of a full day (24 hours), which in this example is Summer. In an aspect and for this example, Summer is assumed to have a daytime temperature warmer than the desired inside temperature. This makes this cooling desirable. This embodiment, as described, will cool when the top cover emits more than the amount of back emittance received and absorbed from the sky.

For a Winter example and heating mode of operation, in which at least the temperature at night is below the desired indoor temperature, the plate is rotated to place the selective heat absorbing Surface 5 up and facing the sky during the daylight hours. This surface is highly absorbent to solar irradiation and the surface substantially absorbs the direct and/or indirect solar irradiation (sunlight). Because this surface is selective in this example, embodiment, and method, it is also low in emissivity in the infrared range. Thus, very little energy is radiated back at the top cover. Thus, a substantial majority of this energy heats up the plate and is not radiated back up to the sky. The plate, which is generally hotter due to this solar gain, radiates out the majority of the radiant heat energy it radiates from the bottom of the plate, as the highly emissive surface of the plate is now on the bottom pointing down. For example, if the emissive bottom surface radiates 90% of a blackbody, and the top selective surface radiates 10%, then 90% of the absorbed energy radiates downward to the bottom cover. The plate being hotter than the bottom cover will transfer net heat energy to the bottom cover, thus transferring heat energy into the enclosure during the day. This mode of operation is referred to as heating mode.

At night. The glass tubes comprising at least a partial vacuum insulate the enclosure to minimize conductive heat losses. (More on this below.) Concurrently, the low emissive surface of the plate minimizes radiant heat transfer between the plate and the top cover (or the bottom cover if the low emittance surface is moved to be the bottom surface when the plate is horizontal—pointed down). Thus, the low emissive surface minimizes radiant heat transfer to the sky, and thus minimizes heat loss, as radiant infrared energy lost needs to move from the bottom cover to the plate, and then to the top cover. Either the radiant transfer from the bottom cover to the plate, or the transfer from the plate to the top cover is inhibited by the low emittance surface, depending on which side is up. This happens as long as the plate is horizontal. Over the course of the night, lost radiant heat has to escape from the enclosure from a surface with low emissivity, which can be less than 10%. Whereas over the course of the day, radiant heat energy is transferred in though a high emissivity surface, which can be greater than 90%.

Once again, the desirable heat transfer will generally outweigh undesirable heat losses over the course of a full day (24 hours). In this case, the heat gain during the daylight hours will outweigh the heat loss at night. The insulating selective surface roofs of the present invention do not generally maintain a consistent temperature inside an enclosure alone, as the heat energy transferred is usually transferred the most when it is needed the least.

In an aspect and embodiment, thermal energy storage (TES) is added to an enclosure comprising the present roof 1. FIG. 10 illustrates a building comprising the insulating selective surface roof surfaces/tiles 1 of the present invention, and some TES. In this example embodiment, the TES 17 is positioned between the roof and the living, work, or commercial space comprising an interior space 16. In an embodiment, the TES comprises phase change materials 17 (PCM) that phase change at a comfortable temperature for the inside of the building. Over the course of a full day, some or all of the PCM undergoes a phase change and stores or releases heat energy that has been added or removed by the roof. By this method, the interior space can be maintained at a substantially constant temperature, or comfortable range.

In an aspect, present day buildings generally comprise insulation, which limits undesirable heat transfer, which is either heat gain or loss depending on the outside temperature. The present embodiments can have positive net energy transfer, which in this context means that net heat energy is transferred in a desirable direction. The present embodiments may maintain an enclosure within a desired temperature range on its own, without any need for external sources of heat transfer. But this depends on the temperature differential from the outside to the desired inside, and on the amount of sunlight and view of clear space, and the amount of insulation of the other sides of the enclosure. Thus, advantages of the present invention include either eliminating common HVAC devices, such as AC or heaters, or simply reducing the energy and/or costs of running HVAC devices.

In an aspect, the term “desirable direction” of heat transfer here within means that net heat energy will be moved from the inside of an enclosure and interior space, which may include a TES, to the outside of the enclosure when cooling the inside is desired, and net heat will be moved into the inside when heating the inside is desired. Desired cooling and heating are in reference to a temperature, or temperature range desired and set by the occupant or designer. Generally, cooling is desired when it becomes too hot inside, and heating is desired when it becomes too cold inside. Too cold or hot refers to a temperature outside of the temperature range, or above or below a temperature, which may be determined by a threshold of temperature difference.

In an aspect, the TES can be moved to another part of the enclosure, or to outside of the enclosure. A conductive path can be used to conduct heat energy into and out of the TES. It is known, and a person skilled in the art knows how to add a conductive path to move heat into or out of TES. A conductive path may comprise heat exchangers and fluid pumped through fluid ducting or pipes, or could simply be conductive material such as aluminum, or other common means.

In an aspect, a TES comprising PCM materials is not necessarily limited to a phase change material that changes phase at a desirable temperature for the enclosure. If the TES is outside the enclosure, and a heat pump is used, the phase change temperature may be different.

In embodiments, the heating and cooling system comprises a heat pump. In an embodiment, the heating and cooling system comprises a heat pump and one or more TESes. In an aspect, the outside temperature to desirable inside temperature may exceed a threshold where the roof alone provides enough heat transfer to heat and/or cool the building or enclosure. In this case, the provided heat pump can consume electricity to move more heat energy into or out of the enclosure.

FIG. 16 illustrates an embodiment comprising an enclosure with an added heat transfer system 105, which in this embodiment is a heat pump 22. The enclosure in this example is a building. The heat pump depicted is a vapor compression heat pump, but it could be another type of heat pump, such as a reverse-Brayton cycle, or thermoelectric. In this figure, the heat pump comprises a pump 26, throttle 27, and three heat exchangers 23, 24, and 25. A common heat pump has two heat exchangers, and in an embodiment, the present invention comprises two heat exchangers—one for absorbing heat and one for rejecting heat. In this figure, the heat pump comprises three heat exchangers—two for absorbing heat and one for rejecting heat in this heating example.

In an aspect, heat exchanger 25 can either be in the space between the roof and the TES, or it can be built into the TES. Heat exchanger 25 directly exchanges heat with the TES 17 in this embodiment, and not indirectly through the interior as would a common heat pump which has only two heat exchangers.

Also, and in an aspect and embodiments, reversing valves may be used to reverse the flow of heat through the heat exchangers. Thus, an enclosure that needs extra heat for cold days or times can have that heat delivered by a heat pump that can also cool the enclosure on hot days or times.

In an aspect, many of the embodiments and methods of RPA Ser. No. 16/554,322 may be used to supplement the heating or cooling provided by the present roof and wall radiant embodiments. Many of the embodiments of this prior application use thermal mass (TES) utilizing phase change materials. The TES used by the radiant walls and roof of the present embodiments may be the same TES as used by the heat pump embodiments in the prior application. Both the radiant selective surface walls and/or roofs, and the heat pump embodiments, can exchange heat directly or indirectly with the same TES.

In an embodiment, a TES comprises a top surface comprising the present selective surface radiant roof. In a further embodiment, the TES with the present selective surface radiant roof covers the ground, and uses the earth as thermal mass storage. Provided a building has sufficient earth beside the building, this can be a TES the building exclusively uses, or it can be a TES that is used in combination with another TES, which may be in the building, or under the building. Further, both a building and an external TES comprise the present selective surface roofs and walls.

In an aspect, other forms of moving heat energy can be used in conjunction with the present radiant selective surface roofs and walls to heat or cool the TES or enclosure. For example, natural convection could be used to cool the TES by opening up windows or vents to allow cool air to flow past the TES at night in the Summer.

In an aspect and embodiments, the rotatable plate does not necessarily need to comprise a cooling selective surface. The bottom cover may comprise a selective surface. In an embodiment, a surface of the bottom cover facing the rotatable plate comprises a selective surface which is highly reflective to solar irradiation, and highly absorptive and emissive to infrared radiation. In another embodiment, this surface may be on the bottom surface of the bottom cover. For these embodiments, the rotatable plate can be rotated to the vertical position during sunlight hours in Summer, or any time heat gain needs to be limited and/or for cooling. FIG. 6 illustrates the cooling selective surface 6 applied to the bottom of the bottom cover 3.

In another embodiment, a top cover comprising transparent material can be added to the insulating selective surface roof to further insulate. This is similar to a triple pane window versus a double plane window. This may be beneficial in very cold climates.

In an aspect, current vacuum glass windows exist. Their insulating R value can be high, such as R-14. At least one example has a U value as low as 0.4 W/(m^2*K). these windows generally require tempered glass to be strong enough to withstand the vacuum forces. These windows use flat glass plates that experience strong bending forces. The present insulating selective surface roof does not have the constraints of needing to be optically clear and accurate, as does a window plane. In an advantage, the “vaulting” of the arches that comprise the covers are a better shape for resisting the force loads of the vacuum, and may not require as expensive and strong glass, such as tempered glass.

In an aspect, the top and bottom covers may use flat glass and may generally be optically clear, with the exception of the movable plates. This is an alternative embodiment.

In another embodiment, the transparent elements of the present invention may also comprise PV materials that turn substantially UV and/or near infrared light into electricity. By this combination, the insulating radiant heating or cooling selective surface, and roof of the present invention, can both move heat directly, and generate electricity, which in turn could be used to move more heat via a heat pump. In an embodiment, the top glass cover comprises one or more transparent PV cells.

Methods of Rotating the Plate with Selective Surface(s)

In the above embodiment and example, a plate is rotated within a stationary vacuum chamber. In an embodiment, the plate is rotated about an axis of rotation 7 using a common axel, as illustrated in FIGS. 2 and 5. The plate in this embodiment is fully inside the vacuum chamber. In an aspect, it would be difficult to maintain a vacuum seal to control, move, and effect the rotation from the outside of the chamber. A solution and embodiment comprises at least one magnet and/or magnetic materials with magnetic poles. In this example embodiment, the plate 4 comprises a plurality of magnetic poles. At least one magnet outside the chamber is moved to rotate the plate within. By this method, there does not need to be a mechanical link from the inside of the vacuum chamber 9 and the outside. Thus, the chamber is more easily sealed.

In an aspect and embodiment, the axis of rotation of the plates may comprise a tube. The radiant plate may rotate about a tube and the tube may comprise a heat transfer fluid that flows through it transferring heat energy between the fluid and the plate.

In an aspect, the plate 4 within the chamber 9 does not necessarily need to be rotatable. If the plate is fixed within the chamber, then the entire chamber itself may be rotated. The chamber in this case is preferably a round tube. A roof comprised of an array of these tubes would then have to rotate. Preferably, every other tube rotates in the same rotational direction with their immediate neighbors rotating in the opposite direction. By this method, there is no sliding friction between the two. However, it would be more difficult to seal and insulate the space where the tubes touch, if they touch. An array of these tubes may have every other tube on a plane slightly higher, to better handle expansion and contraction problems with different temperatures. This would be a staggered array.

In an aspect and embodiment, a plate that rotates about an axis is not limited to having an axel to rotate about. In an embodiment, as illustrated in FIG. 6, the rotatable plate comprises small wheels 8 about its perimeter. In another embodiment, the chamber comprises small wheels that rotate to rotate the plate. Or, and in another embodiment, the wheels are wheels or spheres that run in grooves such as balls in bearings to provide rotation.

FIGS. 3, 4, 7-9, 11-13 illustrate plates within the vacuum chambers that are rotated by magnetic force. Due to magnetic attraction and repulsion, rotating one of the plates can rotate all of the plates in an array of chambers and plates. In an aspect, an array is one or more.

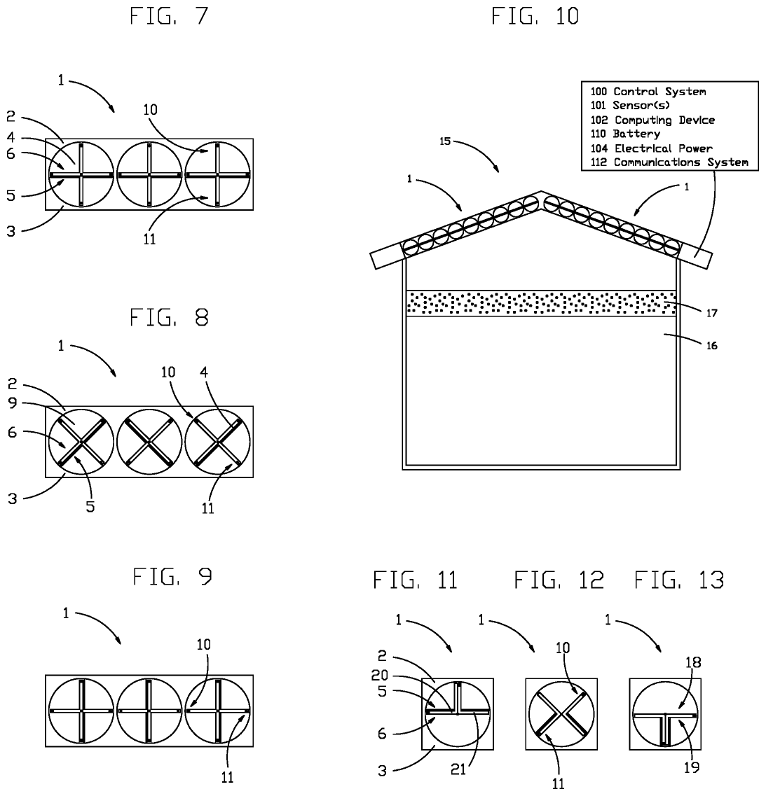

FIGS. 7-9 illustrate how the plates rotate. If the left plate is rotated in the counterclockwise position, the middle plate will rotate in the clockwise direction, and the right plate will rotate in the counterclockwise position by a commensurate amount, as shown in the sequence from FIG. 7 to FIG. 9. By this method, one controller can rotate all plates in an array.

In an aspect, ferrous and/or magnetically susceptible materials can be added inside or outside of the chambers to transfer the magnetic forces from the magnets, much in the way that a line of nails can be picked up by a magnet. By these means, a force to rotate plates may be transferred through chambers aligned from end to end. Thus, a multidirectional array may also be rotated and controlled from one controller. However, and in an aspect, there may be more than one controller, and some plates and arrays can be moved differently from others.

In an aspect, the benefits of using magnets to move the plate(s) are also useful to embodiments that comprise gas in the chamber, instead of a vacuum. Avoiding mechanical movement through a seal is generally useful to maintaining different environments of gas or pressure.

Methods of Control

In an embodiment, a controlling set of one or more magnets can control all rotatable plates in an array, which may be a multidimensional array. As illustrated in FIGS. 10 and 16, the control system 100, also referred to as a controller, comprises a PV panel or electrical source for power 104, and one or more common features of a control system, such as sensors 101, a computing device 102, and a communications system 112. The control system can be simple, or a smart controller. It is within the skill in the art to make a control system that can enable a user, or owner, to set a desirable temperature or temperature range for the roof to try and maintain, or any desirable behavior, such as opening the plates to let light through. In an aspect, a computing device may comprise a clock 103, data 106, CPUs, etc. Sensors may comprise temperature sensors, light sensors, or other sensors.

In an embodiment, the controller comprises at least one PV cell 111 and a battery 110, so it can function independent of any external power source. In an aspect and advantage, roofs are generally not wired, so this eliminates any need to run power to the roof. In an embodiment, the controller can be set or programmed through wireless communications. In an embodiment, the controller is connected to a network, which may be the internet. In an embodiment, an app, which may run a mobile device controls the settings or programming or receives status data from the selective roof.

In an alternative embodiment, the power source comprises a thermoelectric device which may be applied to the temperature difference between the outside of the roof or walls, and the inside space to generate the electricity needed to rotate the plates. A battery can be further added to store the electricity. The diurnal temperature swing may thus be used to power the device and rotate the plates. In an aspect, a capacitor can be used for a battery.

In an aspect, the control system may communicate data with an outside source. Examples of data are temperature data, or a determined charge level of the thermal mass, or other data. In an aspect of these insulating selective surface embodiments, they are not by themselves smart grid connected energy or thermal energy sources, but they could communicate data that tells other devices whether or not they will be needed. For example, a radiant roof or wall controller could determine if a heat pump will need to operate currently or in the future to maintain a desired interior temperature, and communicate with the grid its current or expected energy use, or when the heat pump might stop.

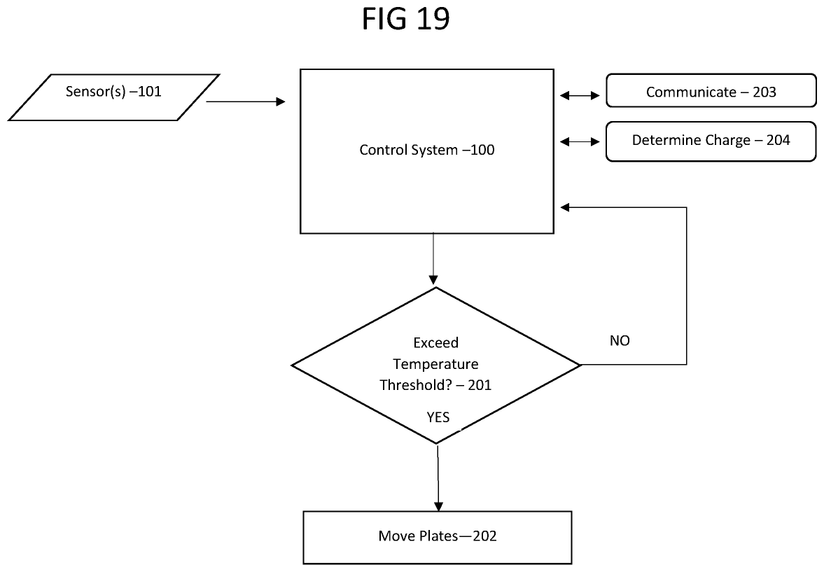

In an aspect, a control system of the present insulating selective surfaces can keep the interior of the enclosure from getting too hot or cold by moving the radiant plates. The control system can comprise temperature sensors. In a method, illustrated in FIG. 19, the control system 100 determines if a temperature exceeds a temperature threshold 201. It so, the control system will move the plates 202 to change the heat energy transferring into or out of the enclosure.

For example, if the sun is out and the selective heat absorbing surface 5 of the plate 4 is rotated up and facing the sun heat will be moving into the enclosure. If the interior gets too hot and exceeds a temperature threshold, the control system will rotate the (black) selective heat absorbing surface to face down, and the (white) reflective and emissive surface 5 to the top to reflect away the sunlight and to stop the heat gain. Likewise, if the interior temperature drops below a lower temperature threshold, the control system will rotate the black absorbing surface back to the top.

By these methods, the present insulating selective surfaces can maintain the temperature of the interior (and/or TES) within a desirable temperature range, for a wider range of outside conditions. In as aspect, embodiment, and method, temperature thresholds can be set above, below, or at the phase change temperature of PCM-based TES. In another aspect and method, the control system can determine an estimated charge level of the PCM. Here, estimated charge level indicates how much of the PCM has phase changed, or how much thermal energy is currently stored in the TES. The control system can use temperature data, temperature differentials, or the amount of sunlight that is currently falling or has fallen on the roof or wall, to estimate heat transfer or charge. The amount of sunlight can be determined from one or more PV cells. Then the control system can use time data from the clock to estimate how much heat has been transferred into or out of the TES. The control system can also set a timer, so an insulating selective surface roof or wall does not constantly switch (hunt) and flip between surfaces, which are usually black and white in color.

In an aspect, the control system may communicate with the electric grid. In a method, the control system receives a message indicating that the cost of electricity is rising soon, or the grid will produce less energy. In response, the control system moves the plates as necessary to ensure the TES is fully charged. In a further method, the control system can control when to run a heat pump that uses the same thermal mass as the insulating selective surfaces. Further, the control system could move the plates to reflect sunlight to charge the TES with the heat pump instead of the sun to consume electricity to balance the grid.

### Other Considerations and Embodiments

In an aspect, it is generally beneficial to minimize the thermal conduction through the cover, as it often occurs in a direction that is detrimental and opposite of the desired heat transfer. FIG. 1 illustrates an array of glass tubes placed side by side. The thinner the glass cross section, the less conduction will occur. FIG. 2. Illustrates merged sides, where the circular shapes merge where they touch. This reduces the cross-sectional area in this area, which reduces conduction through the glass compared to the embodiment of FIG. 1. In another embodiment, the top cover and the bottom cover comprise two or more pieces, as illustrated in FIG. 5. They are joined at an intersection that comprises arc shapes. The middle-left column shows a close up of an arc shape 31 of the bottom cover. This arc meets and compresses against an arc shape 30 on the top cover, and it has a radius that is larger than arc 30. In this example and embodiment, both radii are above the intersection, but they are not limited to this position.

The right column of FIG. 5 comprises a circular cross-section 32 that is placed between two arcs, which both have the radius of arc 31. The arcs have a greater radius than that of the circular cross-section. In embodiments, these cross-sectional shapes can be extruded or revolved into three dimensional shapes.

In the Ideal case, the amount of material in contact between the top and bottom covers comprises a differential of area. In practice, and using real materials, the area in contact is defined by the deformation caused by the difference in outside pressure to inside pressure. However, glass, and many other cover materials are generally very resistant to deformation, which minimizes the conduction area. Thus, the conduction through the covers is minimized in these embodiments. The conduction area can be small enough for vacuum sheets (top and bottom covers) to be competitive with vacuum insulation panels that rely on core insulation materials to handle the compressive loads.

In an aspect, the temperature of the top is often different to the temperature of the bottom. This causes one cover to expand relative to the other. In the embodiments, some of which are illustrated in FIG. 5, this can occur without breaking the seal of the vacuum.

In an aspect and embodiments, the top cover is a transparent material, such as glass, and the bottom cover is material that deforms more elastically and can handle large cyclical loads, such as stainless steel, titanium, or other materials. In this case, the linear expansion and contraction of the top cover though temperature cycles that occur over the course of a day, and seasons, will not break the top and bottom covers, as the more elastic material can elastically deform to match the expansion and/or contraction of the other less elastic material.

In an embodiment, the top and/or bottom of an array of one or more chambers comprise flat outer surfaces—tops/bottoms. This minimizes the surface area with which heat energy is conducted or convected into or out of the one or more covers. This is illustrated in FIG. 6 which shows extra cover material filling in the valleys between the chambers, thus creating a flat top and bottom surface. Either the top or bottom, or both can be flat. It may be beneficial to increase the conductive area of one side. For example, the bottom cover could comprise fins to better exchange heat energy with the enclosure below. In an aspect, extra material can be added for structural strength.

In an aspect, if the top and bottom covers, and/or chambers are transparent, then the rotatable plate can be oriented perpendicular or vertical, or an angle that is not horizontal, with respect to the outside cover, to open to allow sunlight to pass through and function as a window. In a method, a control system opens one or more rotatable plates to allow visible light to pass from the outside to the inside of an enclosure.

In an aspect of the invention, each chamber may comprise a plurality of rotatable plates, or other means of switching between surfaces with differing radiant properties. For example, and in an embodiment, two plates that comprise right angles can be used per chamber. FIGS. 11-13 illustrate this. One or more plates, each of which comprise two rectangles at 90 degrees to each other, can be rotated and/or moved on one or more axis. FIG. 11 comprises a left plate 20 and a right plate 21. FIG. 12. Illustrates the left and right plate as they are being rotated. In this example case, the left case is rotated counter-clockwise and the right plate is rotated clockwise. FIG. 12 illustrates the plates having been rotated 45 degrees from their original positions, while FIG. 13 illustrates the plates having been rotated 90 degrees from their original positions. In FIG. 11, a first selective surface 5 faces the sky. A second surface 6 faces the enclosure. Once the plates are rotated to position of FIG. 13, a third surface 18 faces the sky, and a fourth surface 19 faces the enclosure. Thus, the ideal sky and enclosure surfaces for maximum radiant heat transfer can be used for a given condition. The plates in this embodiment can further be rotated upside down from what is shown in the figures. Thus, more combinations of surfaces can be used. For example, if surfaces 18 and 19 are low emittance surfaces, then this embodiment may better insulate. If surfaces 10 and 11 are high emittance surfaces, then surface 11 will absorb infrared radiation from the enclosure when in the position illustrated in FIG. 12. Then the heat energy will be conducted to surface 10, and emitted up to the top enclosure for cooling at night, as illustrated in FIG. 12. These are alternative embodiments.

In an aspect, the “roof”, which is the present invention, is not limited to being a roof. It can be a wall at any angle. South facing windows, in particular, are often exposed to generous sunlight, and they may benefit from being an insulating selective surface for heating and/or cooling. Other windows may benefit from a rotatable plate within a vacuum chamber that can open for light, or close to better insulate. Also, many windows have a view of the sky, and can be used for cooling.

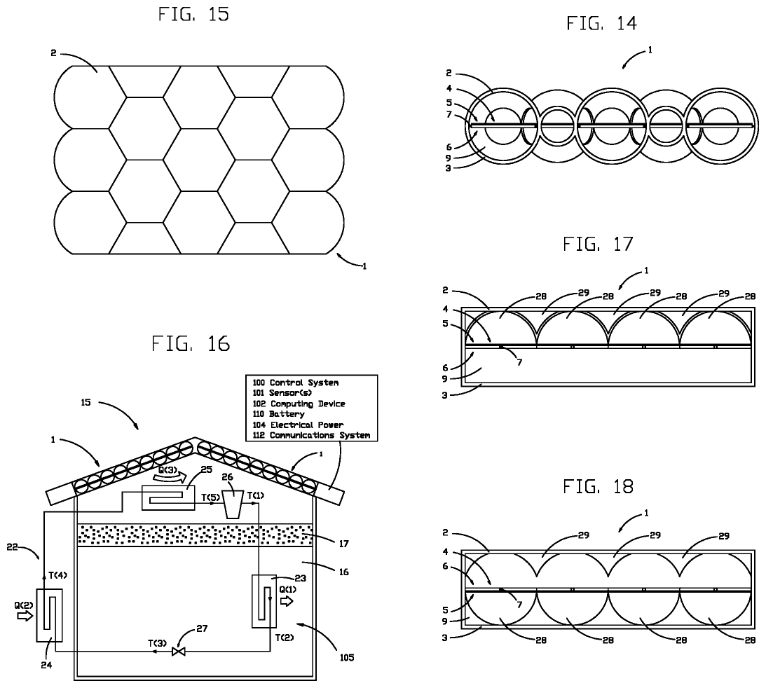

In an aspect, chambers have generally been shown in the figures as one-dimensional arrays. But the invention is not limited to this. For example, two dimensional arrays can be used, as well as any pattern, preferably if the shapes closest pack. For a further example and embodiment, FIGS. 14 and 15 illustrate an array of hexagons that comprise the chambers 9, and top and bottom covers 2 and 3. FIG. 14 is a cross-sectional view. FIG. 15 illustrates a top view. An advantage of this design is that the compression support for the top and bottom covers comprises very thin columns with small cross-sectional area. From architecture, it is clear that this design provides the minimum area for conductive heat transfer between the top and bottom.

In an aspect and embodiment, the rotatable plate may comprise one or more other selective surfaces sandwiched between the outer radiant surfaces of the plate. In an embodiment, a selective surface comprises a radiant concentrator that moves heat energy from one side to the other through one or more radiant concentrators changing the radiant flux. Heat energy is moved to the side on the rotatable plate with the higher radiant flux. In an embodiment, the side receiving the higher radiant flux also comprises the side with a highly emissive surface in the infrared.

In an aspect and embodiments, the present insulating selective surfaces may be integrated into roof tiles. They can be mixed with other roof tiles. They can also be combined with existing PV panels.

In an alternative embodiment, the top cover is not transparent, but opaque. The top of the top cover comprises a heat absorbing (black) selective surface, and the inside and bottom of the top cover's surface is highly emissive. The inside and top of the bottom cover's surface is also highly emissive. This embodiment will not reflect sunlight. The plates within the chambers are low in emissivity and can limit and control heat transfer, depending on how they are positioned. Positioned vertically, they easily pass radiant heat transfer between the top and bottom covers, and thus between the inside and outside of the enclosure. Positioned horizontally, the transfer of radiant heat energy is substantially blocked. This embodiment may be useful in very cold climates that limit how hot the top cover may get via convective heat loss with cold outside air.

Method of Creating a Vacuum

In a method, a top cover is brought close in distance to a bottom cover while hot. The heat of the covers heats the air between the two covers. This heating reduces the density of the air between the covers. Once the air is sufficiently warmed, the covers are brought together in contact to each other. As the covers cool, the air within the chamber cools and drops in pressure creating a partial vacuum. The differential in air pressure will then keep the covers together and from separating. Other methods of creating a vacuum in the chambers can also be used. In an aspect, gas other than air can be used with this method.

In an aspect, “getter” materials may be used to absorb gas that remains in the chamber, as is common in the art.

### Aerogel Embodiments

In an aspect, aerogel is a material that is generally transparent to visible light, including sunlight, and also very insulating in regards to thermal conduction. Yet aerogel possesses low emittance to long wavelength infrared. A highly absorptive (black) surface may be combined with a layer of aerogel to make an excellent substitute for the highly absorptive selective heat absorbing surfaces of the embodiments disclosed above.

FIG. 17 illustrates an embodiment comprising aerogel insulation. Aerogel 28 in this example embodiment is applied and attached to the absorbing surface 5. The absorbing surface in this figure may be either a selective absorbing surface, or a more common absorbing (black) surface that is both absorptive in both the visible and infrared ranges. Aerogel 28 is depicted as having a half circular cross section. This is the shape that maximally fills the space so that the plate can maintain its rotatability. This embodiment is not limited to this shape, as less aerogel can be used.

FIG. 18 illustrates the same embodiment, but with the absorptive aerogel surface 5 rotated to face downward. In this figure, the reflective and emissive surface 6 is on top.

In an embodiment, aerogel 29 is optionally added to fill in the spaces outside of the space within which the rotatable plate rotates for greater conductive insulation.

In an aspect, aerogel is highly insulative. While it conducts more than a vacuum, aerogel can negate the need for a vacuum for some climates or uses. Embodiments using aerogel can provide the advantage of not having to maintain a vacuum, or fill of less conductive gasses, through seals over time. In an embodiment, the chamber 9 of the insulating selective surface 1 (roof or wall) is filled with air. In other embodiments, the chamber is filled with another gas, such as argon.

In an aspect, any material that possesses similar properties to aerogel may be substituted. Transparent wood is both transparent to sunlight, yet insulates with regard to thermal conduction, and may be used in place of aerogel. Also, aerogel is a name for a range of materials and compounds. The invention is not limited to a specific compound. Any material may be substituted that provides the performance described.

### SUMMARY, RAMIFICATIONS, and SCOPE

The embodiments, methods, examples, and aspects of the embodiments and invention are disclosed herein to summarize the invention and are not intended to limit the scope of the invention.

The present disclosure generally relates to moving heat radiantly into or out of an enclosure. Embodiments have a plurality of radiant surfaces, some of which may be selective surfaces, which can be moved to a position in which they provide desirable radiant energy transfer. Embodiments can move heat into an enclosure, move heat out of the enclosure, and/or insulate the enclosure depending on how the surfaces have been moved. Embodiments comprise a transparent top cover. Some embodiments comprise a rotatable plate within a vacuum chamber.

The purpose and use of the present invention is to provide heating when desirable, and/or cooling when desirable, with net beneficial heat transfer over a full day. That is, the heat energy moved in a desirable direction is greater than the heat energy lost through conduction in an undesirable direction.

Many of the disclosed embodiments behave in a manner desired by the user or owner, including reducing operational costs. Further, methods and embodiments comprising control and communication with a network for the use of maintaining a desirable temperature within an enclosure, and an ability to favorably compete with common HVAC have been disclosed. In some embodiments, the user can also control the amount of sunlight let into an enclosure.

None of the elements recited in the claims are intended to be a means-plus-function element within the meaning of 35 U.S.C. § 112 (f) unless an element is expressly recited using the phrase “means for,” or in the case of a method claim using the phrases “operation for” or “step for.”

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The disclosure of the present invention as well as any references to preferred embodiments and other embodiments, are not for limiting the scope of the invention. Persons having ordinary skill in the art may make various modifications and changes without departing from the scope and spirit of the invention. Therefore, the scope of the appended claims should not be limited to the description of the embodiments described above. Accordingly, the scope should be determined not by the embodiments illustrated, but by the claims and their legal equivalents.

I claim:

1-23. (canceled)

24. An insulated selective surface for the use of moving net heat energy into and/or out of an enclosure in a desirable direction; the surface comprising a top side or cover which substantially faces the sky, and a bottom side or cover which faces the enclosure, wherein between the top and the bottom sides or covers comprises a chamber and within the chamber is a moveable plate; the movable plate comprising at least two surfaces, with at least one of the surfaces comprising a selective surface.

25. The insulated selective surface defined in claim 24, wherein at least one of the selective surfaces of the movable plate is a first surface that is highly absorbent to sunlight in a visible wavelength range, and low in emittance in a long wavelength range, and a second surface that is highly emissive.

26. The insulated selective surface defined in claim 24, wherein at least one of the selective surfaces is a second surface that is highly reflective to sunlight in a visible wavelength range, and high in emittance in a long wavelength range, and a second surface that is highly absorptive to sunlight.

27. The insulated selective surface defined in claim 24, wherein at least one of the selective surfaces is a first surface that is highly absorbent to sunlight in a visible wavelength range, and low in emittance in a long wavelength range, and at least one of the selective surfaces is a second surface that is highly reflective to sunlight in a visible wavelength range, and high in emittance in a long wavelength range.

28. The insulated selective surface defined in claim 24, wherein the chamber comprises a vacuum or partial vacuum.

29. The insulated selective surface defined in claim 24, wherein the chamber comprises a gas.

30. The insulated selective surface defined in claim 25, wherein the moveable plate can be moved to a plurality of positions, wherein a first position places the first surface substantially facing the top cover, and the second surface substantially facing the bottom cover, wherein the plate will absorb sunlight and emit a substantial majority of radiant energy coming from the plate toward the bottom cover, which in turn moves the heat energy into the enclosure.

31. The insulated selective surface defined in claim 26, wherein the moveable plate can be moved to a plurality of positions, wherein a second position places the second surface substantially facing the top cover, and the first surface substantially facing the bottom cover, wherein the plate will reflect sunlight and emit a substantial majority of radiant energy coming from the plate toward the top plate.

32. The insulated selective surface defined in claim 24, wherein the movable plate is moved to a position wherein the plate is substantially perpendicular to the top and bottom covers;
wherein the plate allows a radiant energy to pass between the top and bottom covers without being reflected or absorbed by the plate.

33. The insulated selective surface defined in claim 25, wherein the first surface is comprised of a highly radiantly absorptive surface and an aerogel layer.

34. The insulated selective surface defined in claim 24, further comprising thermal energy storage.

35. The insulated selective surface defined in claim 34, wherein the thermal energy storage further comprises phase change materials.

36. The insulated selective surface defined in claim 34, wherein the thermal energy storage is within the enclosure.

37. The insulated selective surface defined in claim 34, further comprising a heat pump.

38. The insulated selective surface defined in claim 37, wherein the heat pump comprises three heat exchangers.

39. The insulated selective surface defined in claim 38, wherein one of the heat exchangers directly exchanges heat energy with the thermal energy storage.

40. The insulated selective surface defined in claim 24, wherein the bottom cover comprises a selective surface.

41. The insulated selective surface defined in claim 24, wherein the top cover comprises one or more transparent PV cells.

42. A method for controlling radiant thermal transfer through an insulated selective surface;
the insulating selective surface comprising a top side or cover which substantially faces the sky, and a bottom side or cover which faces an enclosure, wherein between the top and the bottom sides or covers comprises a chamber and within the chamber is one or more moveable plates;
the movable plate(s) comprising at least two surfaces, with at least one of the surfaces comprising a selective surface; wherein the method comprising:
(a) determining a temperature within the enclosure;
(b) determining if the temperature exceeds a temperature threshold;
(c) moving the plate(s) to change an amount of net heat energy into and/or out of the enclosure.

43. The method defined in claim 42 wherein the enclosure comprises a thermal energy storage that further comprises a phase change material.
